(19) United States
(12) Patent Application Publication
(10) Pub. No.: US 2026/0180076 A1
(43) Pub. Date: Jun. 25, 2026

(54) BATTERY CELL FOR A BATTERY MODULE AND MOTOR VEHICLE

(71) Applicant: AUDI AG, Ingolstadt (DE)

(72) Inventor: Uwe GERLINGER, Kipfenberg (DE)

(73) Assignee: AUDI AG, Ingolstadt (DE)

(21) Appl. No.: 19/414,985

(22) Filed: Dec. 10, 2025

(30) Foreign Application Priority Data
Dec. 19, 2024 (DE) 102024139056.5

(51) Int. Cl. H01M 10/663; H01M 10/613; H01M 10/625; H01M 10/647; H01M 10/653; H01M 10/6555; H01M 10/6569

(52) U.S. Cl. CPC H01M 10/663; H01M 10/613; H01M 10/625; H01M 10/647; H01M 10/653; H01M 10/6555; H01M 10/6569; H01M 2220/20

(57) ABSTRACT

A battery cell for a battery module of an electric vehicle, multiple electrodes with base surfaces and at least one side surface, at least one cooling element with a contact surface, at least one separating element and at least one heat conducting element. The cooling element is thermally connected to the heat conducting element via the contact surface. The base surface of the electrode is many times larger than the at least one side surface of the electrode. A respective separating element is arranged between each of two base surfaces of two adjacent electrodes. The electrodes are in each case thermally connected via the heat conducting element to the cooling element. The at least one cooling element is arranged so that the at least one side surface of the electrodes is oriented in the direction of the contact surface.

### FIELD

The invention relates to a battery cell for a battery, as well as to a motor vehicle.

### BACKGROUND

Efficient cooling of battery cells is a key challenge in the development of battery systems for electric vehicles (EVs). Given increasing energy densities, compact cell geometries and dynamic load profiles, reliable thermal management is essential to ensure the safety, performance and lifespan of the batteries. The electrodes, in which the electrochemical reactions take place, are particularly subject to high thermal stress. Insufficient heat dissipation can lead to degradation, loss of performance and, in the worst case, thermal runaway, which compromises the safety of the battery.

One of the biggest challenges in battery cooling here lies in the heterogeneous heat distribution within the battery cells and between the battery cells of a battery module. Different temperature ranges accelerate the aging of individual battery cells, leading to an imbalance in the battery system. In addition, the increasing energy density of modern batteries increases thermal resistance, while the limited installation space in motor vehicles makes the integration of cooling systems difficult. Furthermore, dynamic charging and discharging processes require flexible cooling solutions that can adapt to the respective heat load.

Heat transfer in battery cells usually occurs via large, lateral housing surfaces of the battery cell. However, the shape of the battery cells here creates constrictions at the respective edges, which disrupts heat transfer. An increase in the cell wall size here leads to adverse values for the ratio of energy content to weight of the battery cell or energy content to total volume of the energy cell.

It is generally known to use thermal conductive elements for the thermal coupling of battery cells or electrodes with cooling elements.

It is known to use auxiliary thermal elements for cooling in battery systems, between battery cells for thermal coupling to cooling plates. This is disclosed in US 2021/0313634 A1.

US 2024/0291079 A1 discloses an auxiliary thermal element that is attached to an electrode, wherein the ends of the auxiliary thermal element are each coupled to the cooling plate.

In US 2022/0021057 A1, auxiliary thermal elements are arranged between battery cells, which thermal elements are coupled to cooling elements via laterally protruding tabs.

Due to the rapid development in the field of battery cells and the increasing demand for ever more powerful battery systems, further improvement of heat dissipation within the battery cells is essential.

### SUMMARY

The object of the invention is therefore to further develop a battery cell of a battery module in such a way that more effective heat dissipation is ensured and in the process the battery cell is designed to save installation space. Furthermore, the aim is to enable the simplest possible integration into existing battery cell structures.

In a known manner, a battery cell for a battery module comprises multiple electrodes with base surfaces and at least one side surface, at least one cooling element with a contact surface, at least one separating element and at least one heat conducting element. The cooling element is thermally connected to the heat conducting element via the contact surface. The base surfaces of the electrode are many times larger than the at least one side surface. The electrodes are arranged inside a housing of the battery cell. A respective separating element is arranged between two base surfaces of two adjacent electrodes. The electrodes are each thermally connected to the cooling element via the heat conducting element. The at least one cooling element is arranged such that at least one side surface of the electrodes is oriented towards the contact surface. The at least one heat conducting element is arranged between the base surface of the electrode and a separating element. The heat conducting element is designed with at least two legs.

According to the invention, one leg lies flat against one of the base surfaces and the other leg is designed parallel to the contact surface of the cooling element. The width of the contact surface corresponds to at least 80% of the width of the side surface. The design of the heat conducting element ensures that, on the one hand, a large effective surface area for heat dissipation is formed at the electrode, and, on the other hand, a large effective surface area is formed for connection to the cooling element.

Preferably, the heat conducting element is designed as graphite or graphene foil. Graphite foils have very high thermal conductivity, especially in the plane of the foil (in-plane). Values exceeding 1000 W/m·K are possible. This ensures rapid heat dissipation in the battery cell. Due to their high isotropic conductivity in the plane, temperature differences within the battery cell can be effectively compensated. Furthermore, the heat conducting element is designed to be resistant to mechanical stress, such as that which occurs during temperature cycles, and in the process it retains its thermal conductivity.

According to an advantageous embodiment of the invention, the heat conducting element is designed as heat pipe plate or vapor chambers. This ensures efficient heat dissipation and a uniform temperature distribution by utilizing the phase change mechanisms of these designs. The heat conducting element here exhibits high thermal conductivity, a small footprint, and high energy efficiency.

Preferably, the legs of the heat conducting element are connected to each other via a rounded intermediate piece. The rounded intermediate piece ensures that the heat conducting element has no edges. Edges of the heat conducting element can lead to uneven heat distribution, which can promote hotspots or local overheating. This ensures an even distribution of heat at the transition between the two legs.

Preferably, a heat conducting gap filling element is arranged between the leg of the heat conducting element associated with the cooling element and the side surface of the electrode associated with the contact surface of the cooling element. The heat conducting gap filling element rests against both the side surface of the electrode and the leg. This allows the rounding of the intermediate piece to have a larger radius. The gap between the leg of the heat conducting element associated with the cooling element and the side surface of the electrode can be filled using the heat conducting gap filling element or gap filler. This eliminates a heat insulating air gap and improves the thermal conductivity between the side surface of the electrode and the leg of the heat conducting element associated with the cooling element.

According to a further advantageous embodiment of the invention, the electrodes are arranged in such a way that a prismatic cell is formed. Their rectangular, cuboid design allows prismatic cells to be arranged in battery systems in a space saving manner. This allows for more efficient use of the available installation space, especially in EV battery packs. The parallel surfaces and edges of the prismatic cells facilitate stacking and integration into a battery module, thereby achieving a high energy density at the system level. The battery cell can also be designed as a pouch cell.

Preferably, the cooling element is designed in two parts. A first partial cooling element is arranged above the electrodes and a second partial cooling element is arranged below the electrodes. The heat conducting element is thermally connected to one or both of the partial cooling elements. By connecting both sides of the electrode to a respective partial cooling element, the effective heat dissipation surface area is doubled, which significantly improves heat dissipation. Furthermore, the additional heat dissipation surface area, provided in each case by means of a leg of the heat conducting element coupled to a partial cooling element, enables more effective cooling, even under high heat loads, and ensures a more uniform temperature distribution.

Preferably, the heat conducting element has a thickness of less than or equal to 2 mm, in particular less than or equal to 1 mm. This ensures a space saving design of the battery cell.

According to a further advantageous embodiment of the invention, the thickness of the heat conducting element is less than the thickness of the cell separating element. The cell separating element primarily fulfills an electrical insulation function, while the heat conducting element is optimized for heat transfer. A reduced thickness of the heat conducting element maximizes its efficiency without impairing the function of the cell separating element.

Another aspect of the invention relates to a motor vehicle comprising at least one battery system interacting with an electric motor. The battery system comprises at least one battery cell as described above. The cooling element is connected to a primary, coolant-based cooling circuit. According to the invention, the cooling element is additionally integrated into a secondary cooling circuit of the vehicle. The cooling circuit here comprises a chiller. By additionally connecting the cooling element to a secondary, coolant-based cooling circuit coupled to a chiller, it is possible to increase the temperature of the coolant circulated through the cooling circuits and therefore increase the overall cooling performance of the motor vehicle due to the more efficient thermal connection of the electrodes to the cooling element. Furthermore, it is also conceivable that the secondary cooling circuit is designed as a coolant-based cooling circuit.

### BRIEF DESCRIPTION OF THE FIGURES

Further advantages and possible uses of the invention will be apparent from the following description in conjunction with embodiments shown in the drawings.

FIG. 1 shows a schematic side view of a first embodiment of a battery cell of a battery module according to the invention, and

FIG. 2 shows a schematic side view of a second embodiment of a battery cell of a battery module according to the invention.

### DETAILED DESCRIPTION

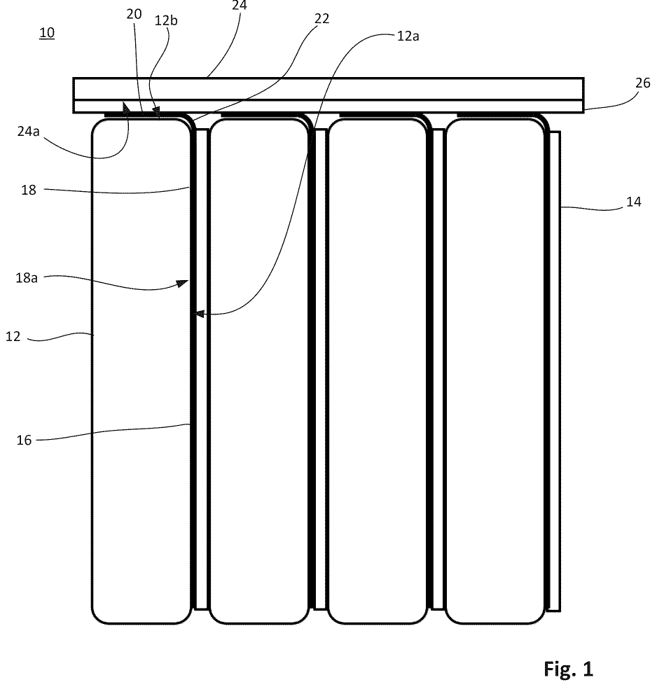

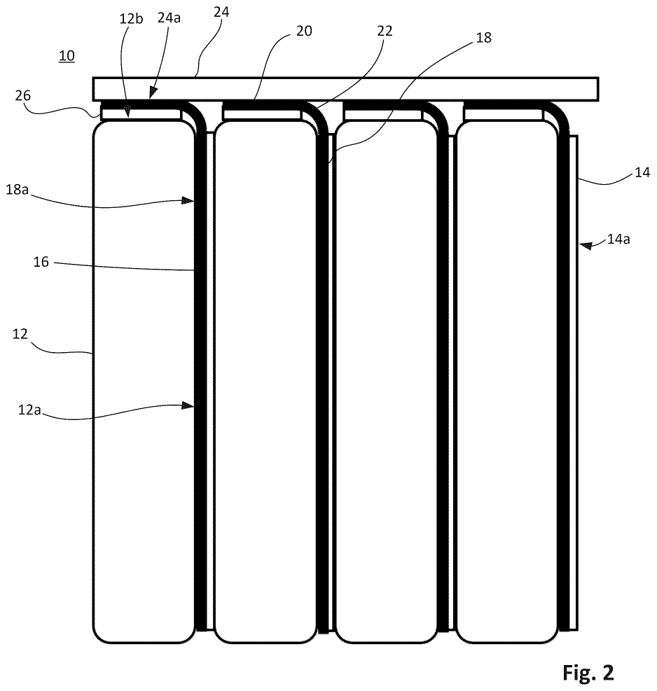

FIG. 1 and FIG. 2 each show a schematic side view of a part of a battery cell 10 according to the invention. The battery cell 10 has a cell housing which is not represented.

The battery cell 10 here has multiple identical electrodes 12. The electrodes 12 here are cuboid in shape and have two base surfaces 12a and four side surfaces 12b. The base surfaces 12a here are many times larger than the side surfaces 12b. The battery cell 10 is designed as a prismatic cell. The battery cell 10 can also be designed as a pouch cell. The electrodes 12 are here arranged in such a way that the base surfaces 12a are respectively completely aligned and the side surfaces 12b of the electrodes 12 are respectively parallel to each other. Each of the electrodes 12 contains active material. Here, for a cathode, lithium nickel manganese cobalt oxide (NMC) or lithium iron phosphate (LFP) are considered suitable materials, for example. For an anode, for example, graphite or silicon-graphite mixtures.

A separating element 14 is respectively arranged between the electrodes 12. Here, the separating element 14 also has two base surfaces 14a and four side surfaces 14b. The base surfaces 14a are designed to be many times larger than the side surfaces 14b. The separating element 14 lies here in contact with a respective one of the base surfaces 14a against a base surface 12a of an electrode 12.

Furthermore, a respective heat conducting element 16 is arranged between the separating element 14 and the electrodes 12. The heat conducting element 16 has two legs 18, 20. The legs 18, 20 are connected to each other via a rounded intermediate piece 22. A first leg 18 has two base surfaces 18a and three free side surfaces 18b. The first leg 18 lies with one of its base surfaces 18a flat against the other base surface 12a of the electrode 12. The other base surface 18a of the first leg 18 lies flat against the other base surface 14a of the separating element 14.

A cooling element 24 is arranged on an upper side of the battery cell 10. The cooling element 24 is here thermally coupled to a coolant-based primary cooling circuit of the motor vehicle. The cooling element 24 can here also be coupled to an additional secondary, coolant-based cooling circuit. The cooling element 24 can be designed as a cooling plate.

The cooling element 24 is directly or indirectly thermally connected to the heat conducting element 16 via a contact surface 24a. The width of the contact surface 24a corresponds to at least 80% of the width of the side surface 12 b of the electrode 12 associated with the cooling element 24.

The heat conducting element 16 has a smaller thickness than the thickness of the separating element 14, with the heat conducting element 16 being thinner than 2 mm.

FIG. 1 shows a first embodiment of the battery cell 10. The heat conducting element 16 is here designed as graphite foil. The heat conducting element 16 can also be designed as a graphene foil.

In the first embodiment of the battery cell 10, the leg 20 running parallel to the cooling element 24 lies flat with one side against the side surface 12b of the electrode 12 associated with the cooling element 24. The other side of leg 20 is connected to a heat conducting gap filling element 26. The heat conducting gap filling element 26 is designed parallel to the cooling element 24 and has a smaller thickness than the cooling element 24. The heat conducting gap filling element 26 is designed as a gap filler and thus, in addition to thermal conductivity, also has flexibility to compensate for measurement tolerances and dampen vibrations. The heat conducting gap filling element 26 is designed as a continuous plate connected flat to the cooling element 24. The heat conducting element 16 therefore has, in addition to the flat connection to one of the base surfaces 12a of the electrode 12, a flat connection to the side surface 12b associated with the cooling element 24 via the first leg 18. Additionally, the intermediate piece 22 of the heat conducting element 16 also rests against the rounded edge of the electrode 12 between the side surface 12b and the base surface 12a. The active surface area for heat dissipation from the electrode 12 through the heat conducting element 16 is therefore large. The heat is then conducted via the leg 20 of the heat conducting element 16 via the heat conducting gap filling element 26 to the cooling element 24.

FIG. 2 shows a second embodiment of the battery cell 10. The heat conducting element 16 is designed here as heat pipe plate or vapor chamber.

In comparison to the design of the battery cell 10 of the first embodiment, the heat conducting element 16 is designed with a greater thickness. Furthermore, the intermediate piece 22 has a larger radius. The heat conducting gap filling element 26 is designed in multiple parts. The leg 20 lies flat against the cooling element 24 with one side and the leg 20 lies flat against a heat conducting gap filling element 26 with the other side. The heat conducting element 16 is directly connected flat to the cooling element 24. To compensate for possible tolerances, air gaps or vibrations, the heat conducting gap filling element 26 is arranged in each case between the leg 20 and the side surface 12b of the electrode associated with the cooling element 24. The heat transfer of the heat conducting element 16 thus takes place on the one hand directly via the base surfaces 12a, 18a and on the other hand via the indirect coupling of the side surface 12b of the electrode to the leg 20 via the heat conducting gap filling element 26.

The cooling element 24 can also be designed in two parts and each part can be formed from two opposing partial cooling elements. The partial cooling elements are each arranged on an opposite side surface 12b of the electrodes 12. The heat conducting element 16 then has three legs, wherein two legs are designed parallel to the partial cooling elements and are thermally connected to them via a respective contact surface.

Furthermore, the battery cell 10 in a motor vehicle can be connected in such a way that, on the one hand, the cooling element 24 is integrated into a primary, coolant-based cooling circuit of the motor vehicle and, on the other hand, it is additionally integrated into a secondary, coolant-based cooling circuit of the motor vehicle. The secondary coolant circuit here comprises a chiller which additionally cools the coolant for the cooling element 24 via the secondary cooling circuit.

By forming the battery cell 10 with a described heat conducting element 16, an effective and powerful heat dissipation within the battery cell is enabled, while the geometric design of the heat conducting element 16 also allows for a space-saving battery cell 10.

1. A battery cell for a battery module of an electric vehicle, comprising: multiple electrodes with base surfaces and at least one side surface, at least one cooling element with a contact surface, at least one separating element and at least one heat conducting element, wherein the cooling element is thermally connected to the heat conducting element via the contact surface, wherein the base surface of the electrode is many times larger than the at least one side surface of the electrode, wherein a respective separating element is arranged between each of two base surfaces of two adjacent electrodes, wherein the electrodes are each thermally connected to the cooling element via the heat conducting element, wherein the at least one cooling element is arranged such that the at least one side surface of the electrodes is oriented in the direction of the contact surface, wherein the at least one heat conducting element is arranged between the base surface of the electrode and a separating element, and wherein the heat conducting element is designed with at least two legs, wherein a leg lies flat against one of the base surfaces and the other leg is designed parallel to the contact surface of the cooling element, wherein the width of the contact surface corresponds to at least 80% of the width of the side surface associated with the contact surface.

2. The battery cell according to claim 1, wherein the heat conducting element is designed as graphite or graphene foil.

3. The battery cell according to claim 1, wherein the heat conducting element is designed as heat pipe plate or vapor chambers.

4. The battery cell according to claim 1, wherein the legs are connected to each other via a rounded intermediate piece.

5. The battery cell according to claim 1, wherein a heat conducting gap filling element is arranged between the leg of the heat conducting element associated with the cooling element and the side surface of the electrode associated with the contact surface of the cooling element, wherein the heat conducting gap filling element is in contact with both the side surface of the electrode and the leg.

6. The battery cell according to claim 1, wherein the electrodes are arranged such that a prismatic cell is formed.

7. The battery cell according to claim 1, wherein the cooling element is designed in two parts, wherein a first partial cooling element is arranged above the electrodes and a second partial cooling element is arranged below the electrodes, and wherein the heat conducting element is thermally connected to one or both partial cooling elements.

8. The battery cell according to claim 1, wherein the heat conducting element has a thickness of less than or equal to 2 mm, in particular less than or equal to 1 mm.

9. The battery cell according to claim 1, wherein the thickness of the heat conducting element is less than the thickness of the separating element.

10. A motor vehicle, comprising: at least one battery system interacting with an electric motor, wherein the battery system has at least one battery cell according to claim 1, and wherein the cooling element is integrated into a primary, coolant-based cooling circuit of the motor vehicle, characterized in that the cooling element is additionally integrated into a secondary, coolant-based cooling circuit of the motor vehicle, wherein the cooling circuit comprises a chiller.

11. The battery cell according to claim 2, wherein the legs are connected to each other via a rounded intermediate piece.

12. The battery cell according to claim 3, wherein the legs are connected to each other via a rounded intermediate piece.

13. The battery cell according to claim 2, wherein a heat conducting gap filling element is arranged between the leg of the heat conducting element associated with the cooling element and the side surface of the electrode associated with the contact surface of the cooling element, wherein the heat conducting gap filling element is in contact with both the side surface of the electrode and the leg.

14. The battery cell according to claim 3, wherein a heat conducting gap filling element is arranged between the leg of the heat conducting element associated with the cooling element and the side surface of the electrode associated with the contact surface of the cooling element, wherein the heat conducting gap filling element is in contact with both the side surface of the electrode and the leg.

15. The battery cell according to claim 4, wherein a heat conducting gap filling element is arranged between the leg of the heat conducting element associated with the cooling element and the side surface of the electrode associated with the contact surface of the cooling element, wherein the heat conducting gap filling element is in contact with both the side surface of the electrode and the leg.

16. The battery cell according to claim 2, wherein the electrodes are arranged such that a prismatic cell is formed.

17. The battery cell according to claim 3, wherein the electrodes are arranged such that a prismatic cell is formed.

18. The battery cell according to claim 4, wherein the electrodes are arranged such that a prismatic cell is formed.

19. The battery cell according to claim 5, wherein the electrodes are arranged such that a prismatic cell is formed.

20. The battery cell according to claim 1, wherein the cooling element is designed in two parts, wherein a first partial cooling element is arranged above the electrodes and a second partial cooling element is arranged below the electrodes, and wherein the heat conducting element is thermally connected to one or both partial cooling elements.
